(19) United States
(12) Patent Application Publication
(10) Pub. No.: US 2005/0131926 A1
(43) Pub. Date: Jun. 16, 2005

(54) Method of hybrid searching for extensible markup language (XML) documents

(75) Inventors: Amit Chakraborty, Cranbury, NJ (US); Sudarshan Sampath, Plainsboro, NJ (US)

Correspondence Address: Elsa Keller;Siemens Corporation, Intellectual Property Department, 170 Wood Avenue South, Iselin, NJ, 08830, US

(73) Assignee: Siemens Corporate Research Inc.

(21) Appl. No.: 10/732,030

(22) Filed: Dec. 10, 2003

(51) Int. Cl. G06F 17/00

(52) U.S. Cl. 707/101

(57) ABSTRACT

A method of generating a searchable database system for storing and querying Extensible Markup Language (XML) documents is disclosed. A Document Type Description (DTD) associated with one or more XML documents is analyzed to determine a scope of XML documents defined by the DTD. A first set of elements associated with the DTD is identified. The first set of elements is mapped to a relational database. A second set of elements associated with the DTD to be stored in an XML database is identified. A collection of classes is created such that each class defines an object schema. The classes are mapped to a set of corresponding tables, and foreign and primary keys associated with the corresponding tables are identified.

### TECHNICAL FIELD

The present invention is directed to a method of hybrid searching for Extensible Markup Language (XML) documents, and more particularly, to a method of hybrid searching XML documents for a particular application and associating the XML documents with a relational database for purposes of archiving and retrieving the documents.

### BACKGROUND OF THE INVENTION

With the rapid spread of the World Wide Web (WWW), many business processes and information dissemination within and outside of an organization have either moved to the web or have expanded to it. The new mode of data collection, document creation and movement is via the XML format. With that however comes the question of effective archival and retrieval of that data. There are two common search philosophies, one that directly searches the XML databases as a collection of files and the other that actually first maps the XML data to a relational database and then search that database. Each one is effective in a limited way depending upon the type of data encountered.

The exponential increase in Internet usage has ushered in a boom in E-business activities around the globe. Everyday numerous organizations, some new and some old are creating hundreds of thousands of web pages touting their services and products. In fact, today with the rapid emergence of the e-marketplace, transactions between different organizations and between the individual customer and a collection of business partners are taking place seamlessly. All of this is being facilitated by the power of the web, which in turn derives its power from the usage of Extensible Markup Language (XML) which is being used as the standard mode of document exchange. The popularization of this standard has helped in the integration process and communication between organizations.

However, to be able to fully exploit the advantages of XML documents, one has to be able to archive and search such documents. Furthermore, the search must be done in a manner that takes advantage of the structured nature of such documents. This is especially true for the case of E-business applications where different products might have to be searched based on their different characteristics or based on their hierarchical position, for example in the case of spare parts. It is also true in any business which carries a large inventory of products, particularly if the products are diverse. For example, a book retailer might want to orgarnize books based on subject matter, author, title, popularity, etc.

It is common knowledge that relational databases are highly efficient for the archival and querying of data that can be tabularized. XML data doesn't necessarily follow a tabularized structure; rather, the strength of the XML representation comes from its hierarchical structured representation. XML data might or might not follow a DTD or a schema.

Actually, an XML document is in itself a database only in the strictest sense of the term since it is simply a collection of data. It has its advantage in the sense that it is portable and that it can describe data in a tree or graph structure. But in the broader sense of the term, XML documents don't quite represent a database as there are no underlying database management systems that can capture and control the data. While XML technology comes with schemas or DTDs that describe the data, query languages such as Extensible Query Language (XQL) and programming interfaces such as Document Object Model (DOM), XML still lacks the main features of a database, such as efficient storage, indexes, security, transactions and data integrity, multi-user access, triggers, queries across multiple documents and so on. Thus while it may be possible to use XML document or documents as a database in a environments with small amounts of data, few users and modest performance requirements, it will fail in most production environments that have multiple users, strict data integrity requirements and the need for good performance.

Mapping simple well-formed XML data to a database is often very inefficient as there are no underlying rules that govern the structure of such information. In such cases it is better to use directly a native XML search strategy that doesn't try to make use of an underlying relational database. However, there might be document segments where the data normally follows a highly regularized structure defined by a DTD or a schema and can often be used by non-XML applications where a relational database approach might be more efficient.

### SUMMARY OF THE INVENTION

The present invention is directed to a hybrid method for searching XML documents that are created for a particular application, such as product descriptions for E-business activities to a standard relational database for purposes of archival and retrieval. The present invention is also directed to a method for processing data that is mixed, i.e. parts of the documents are highly structured and easily represented by tables and other parts of the documents make use of mechanisms such as entities and other XML features that make direct representation by a relational database inefficient, both in terms of space (by resulting in a number of empty or at best sparsely populated tables) and search time.

In accordance with the present invention, a method of generating a searchable database system for storing Extensible Markup Language (XML) documents is disclosed. A Document Type Description (DTD) associated with one or more XML documents is analyzed to determine a scope of XML documents defined by the DTD. A first set of elements associated with the DTD is identified. The first set of elements is mapped to a relational database. A second set of elements associated with the DTD to be stored in an XML database is identified. A collection of classes is created such that each class defines an object schema. The classes are mapped to a set of corresponding tables, and foreign and primary keys associated with the corresponding tables are identified.

In accordance with another embodiment of the present invention, a method of performing a hybrid search of Extensible Markup Language (XML) documents where a first set of segments of the XML documents are stored in a first database and a second set of segments of the XML documents are stored in a second database is disclosed. A query string is received and a query type for the query string is identified. If the query is an XPath statement, a location of a start tag for the query string is identified. A determination is made as to whether the query in the start tag is directed to the first database or the second database. The appropriate database is queried. Each subsequent element in-the query is identified. A determination is made as to whether each subsequent element is directed to the first database or the second database. For those elements that are directed to the first database, each XPath statement substring is converted to an advanced search query. The advanced search queries are mapped to an appropriate table and the advanced search queries are performed. The results of the advanced search queries are combined to obtain search results.

### BRIEF DESCRIPTION OF THE DRAWINGS

Preferred embodiments of the present invention will be described below in more detail, wherein like reference numerals indicate like elements, with reference to the accompanying drawings:

FIG. 1 is an illustrative schematic diagram of a method for generating a database from a collection of XML files in accordance with the present invention;

FIG. 2 illustrates a flow chart that depicts the steps for performing the DTD analysis in accordance with the present invention;

FIG. 3 illustrates a flow chart that depicts the steps for identifying tabular structures in a DTD segment in accordance with the present invention;

FIG. 4 illustrates a flow chart that depicts the steps for populating the database in accordance with the present invention; and

FIGS. 5A and 5B illustrate a flow chart that depicts the steps for formulating a database query in accordance with the present invention.

### DETAILED DESCRIPTION

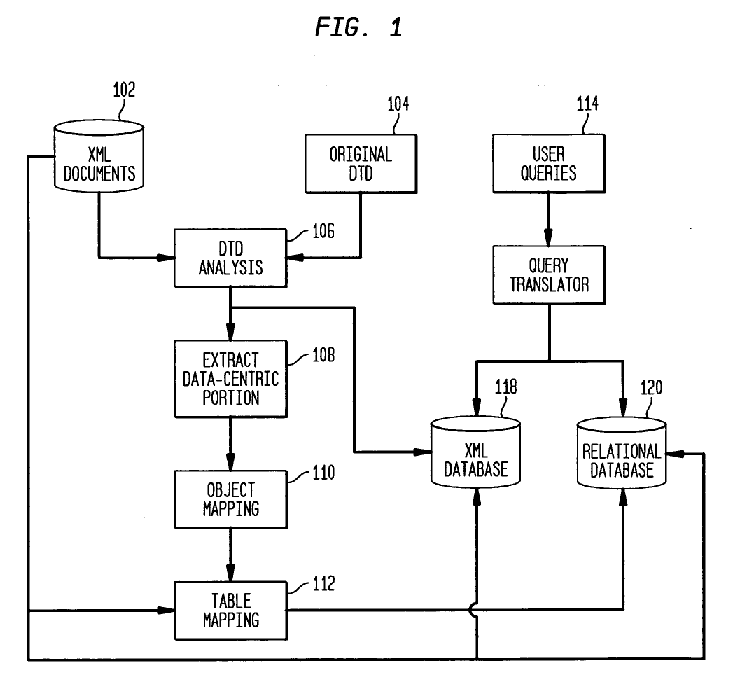

The present invention is directed to a method of hybrid searching for XML files that comprise different types of data. FIG. 1 illustrates an exemplary method for generating a database from a collection of XML files in accordance with the present invention. The first step is to analyze the Document Type Definition (DTD) or the schema that defines the product offerings for each DTD and XML file or document (102, 104, 106). During this step the most important elements, attributes, subgroups and the like are identified. Parent-child relationships, sibling relationships, groupings, and nested hierarchies are observed and identified. Sometimes the DTDs are very generic, but the full scope of the DTD is not necessary to characterize the class of documents under consideration. So, in order to be able to optimize the database in terms of the number of tables and columns, the first task is to note not only the DTD, but also representative documents to identify their scope.

The second step is to be able to isolate those parts of the DTD that need to be mapped to a relational database and others that will be left alone to be used by a native XML database (108, 118, 120). As a general rule, repeatable and non-tabular elements are not mapped to a relational database whereas tabular elements in particular are mapped to a relational database.

The third step is to be able to design a collection of classes, which serve as an intermediate step in the design process (110). The classes define the object schemas and describe in clearer terms the relationship between different classes and the granularity of the underlying data.

The fourth step in the process is to map the above classes to corresponding tables and further to identify the foreign and primary keys of the different tables (112). The table mapping effectively defines the database schema. It is important to make sure that all available and likely documents are appropriately mapped. Further, it is important that the relationships between the different tables are mapped properly enough for any XML query to be translated to a corresponding database query.

The final step is to be able to map the queries into a collection of steps that direct the queries to the corresponding part of the system that holds the data (114, 116). In general, any query that tries to fetch a whole document or part of the underlying XML tree, can involve both interfaces.

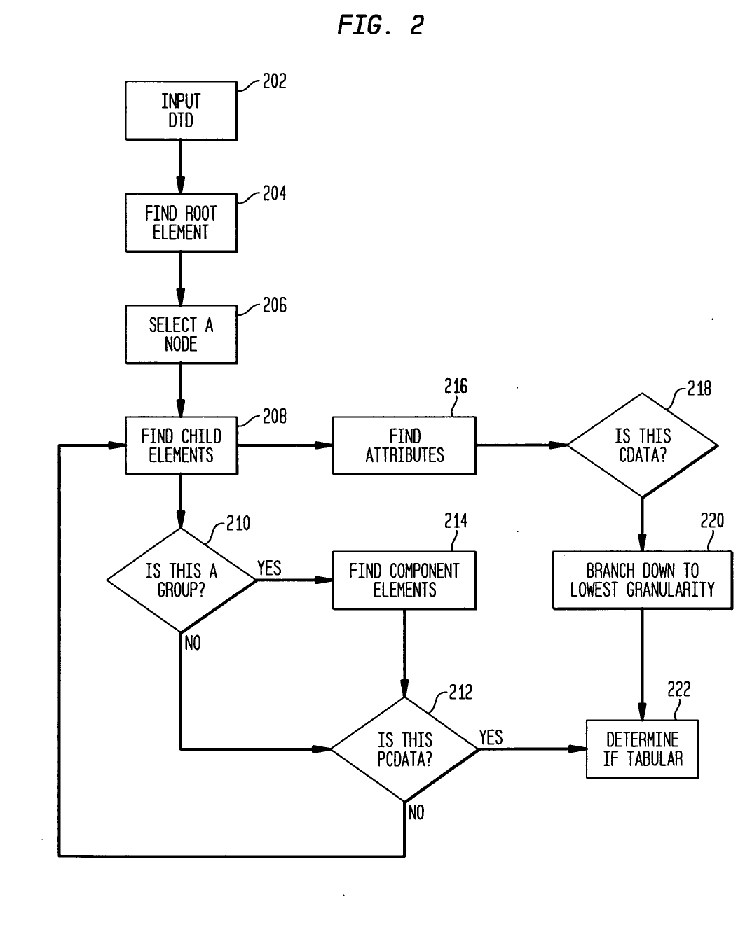

As indicated above, the first step in generating the database is the analysis of the underlying DTD (106). FIG. 2 illustrates a flow chart that depicts the steps for performing the DTD analysis in accordance with the present invention. The main purpose of the DTD analysis is to be able to isolate segments of the DTD that need mapping to a schema that can be used by a relational database.

A DTD is inputted (202). For those segments of the DTD that are identified to be segments that should be mapped to a conventional database, the main elements and attributes of the segments are identified to simplify the nested elements and to linearize the structure. In accordance with the present invention, the root element of the DTD segment is identified (204). A node within the root element is selected and the children and attributes associated with the selected node are identified (206, 208, 216). Next it is determined if the child element is a group (210). If the child element is a group, then the components of the group are identified (214). If the child element is not a group, a determination is made as to whether each child element is Parsable Character Data (PCDATA) (212). If the child element is not PCDATA, then all of the children are identified (208).

Next, for each element, the attributes are identified (216). A determination is made as to whether the attributes are Character Data (CDATA) (218). If the attributes are CDATA, the attributes are branched down to the lowest granularity. A check is also made to determine if a subtree exists at different locations in the DTD and if a subtree has a tabular structure underneath (222). The method described above simplifies the DTD and identifies the elements and attributes that are actually used and need mapping to the database schema.

However, there are other segments of the DTD that are not mapped to the database; however they are linked and hence to the user it appears to be an integrated system. The last two steps identify which subtrees are mapped to a relational database. If a similar subtree exists at different locations in the DTD, and if these subtrees have an internal tabular structure, the subtrees can be mapped to a single table with a primary key that identifies the XML parent. The subtrees can also be mapped to different tables.

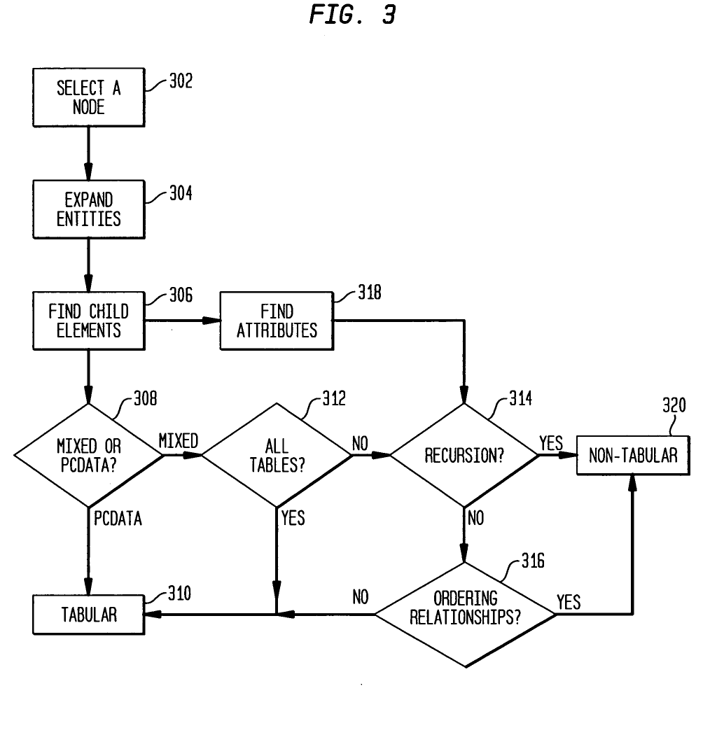

Step 222 of FIG. 2 is described in more detail in FIG. 3. An important aspect of the present invention is the identification of a tabular structure and determining which tabular structures warrant a mapping to a relational database. If an element contains a table then it clearly falls in this category. A node of the DTD segment is selected and expanded into its entities definitions (302, 304). If the element does not contain a table, a check is made of the children and their respective attributes (306, 318). If all the children are either tables or PCDATA, then the children are determined to be tabular (308, 312, 310).

A determination is made as to whether an element or sub-element thereof has recursion built in (314). If there is a recursion, most likely it is not a suitable candidate for tabular description (320). The entity definitions are also expanded that might exist for attributes and sub-elements or the concerned node. If after expansion, either CDATA or PCDATA definitions are found, this node is considered to be tabular. If however, one or more of the sub nodes have mixed content and the non-PCDATA sub elements are not tables, the node is most likely non-tabular. Finally a check is made as to whether there is any logical relationship in the orderings of the sub elements and PCDATA in the case of mixed content (316). If there is a logical relationship, it is likely not tabular (320).

Next, the DTD segments described above are mapped to objects and classes. As mentioned before, this is actually an interim step that is meant to identify the tables and relationships between the tables, which in turn, identify the primary keys and the foreign keys for the segment. For each DTD segment, all elements that have children are identified and a class is associated with them. If an element or attribute is of type PCDATA, a terminal string variable associated with the element or attribute. Elements that have children are associated with the corresponding class. If an element is repeatable, arrays are associated with the element. Attributes of type CDATA are associated with string classes.

The mapping process is completed by going from the object schema to the table description. This is the final step in the database creation process. The schema description generated from the classes as well as the inference from the XML files are used to characterize the column elements. A table is associated with each class unless the class represents a table subpart. If there is a child that in itself is a class, a foreign key is created for the child. If a class is a child of another class, a primary key is defined for that class. All string classes are mapped to columns. If a string is a class and a table row, the string is mapped to a simple row. If any class is an array, it is mapped to a table.

In accordance with the present invention, one of the most important steps is that of populating the database, both the native XML part of it as well as the relational database part of it. Database population is important because it is here that the documents are broken up and segments that are supposed to be stored in a relational database are taken out and stored there. However, the document that is stored as regular XML carries a reference to the table where the rest of the document is continued.

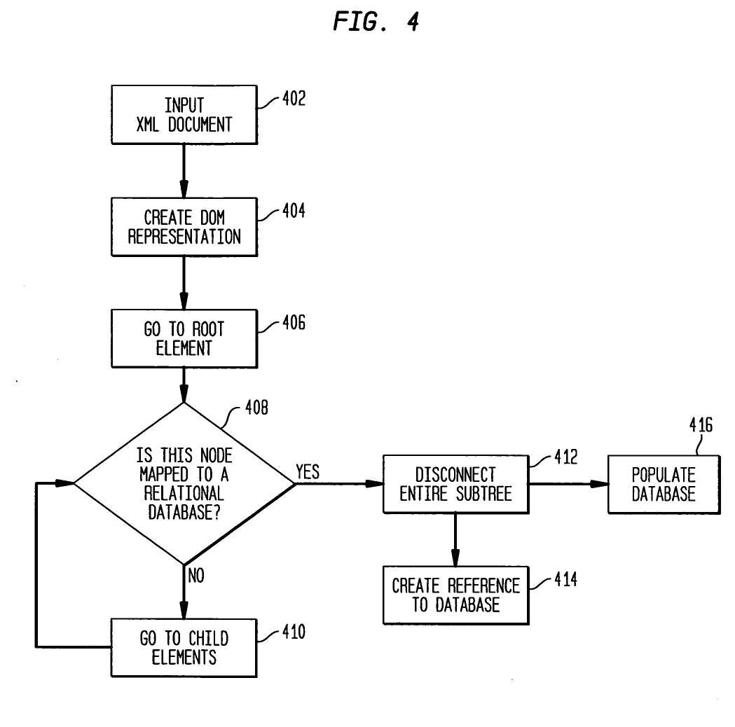

FIG. 4 illustrates the steps for populating the database in accordance with the present invention. An XML document is inputted and a Document Object Model (DOM) representation is created for the XML document (402, 404). Next the root element is identified (406). For each node associated with the root element, a determination is made to see whether the node in the DTD is to be mapped to a relational database table (408). If the node is mapped to a relational database, the node is disconnected and a reference is created to the appropriate database table (412, 414). The data in the severed node is populated to the appropriate database tables following the schema defined earlier (416). The same method is repeated for the next node. If the node in question is not mapped to a relational database, the child elements of the node are examined (410).

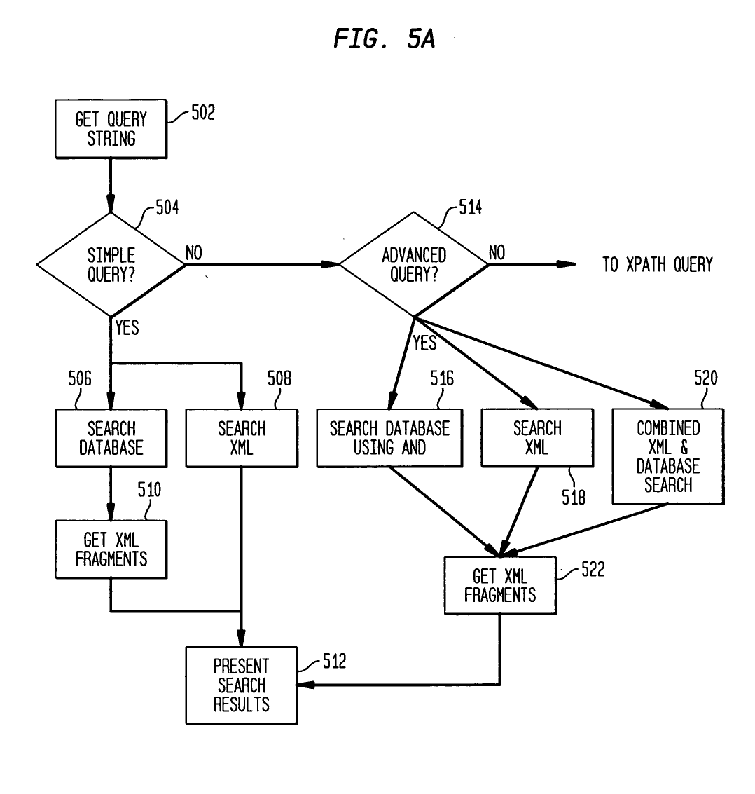

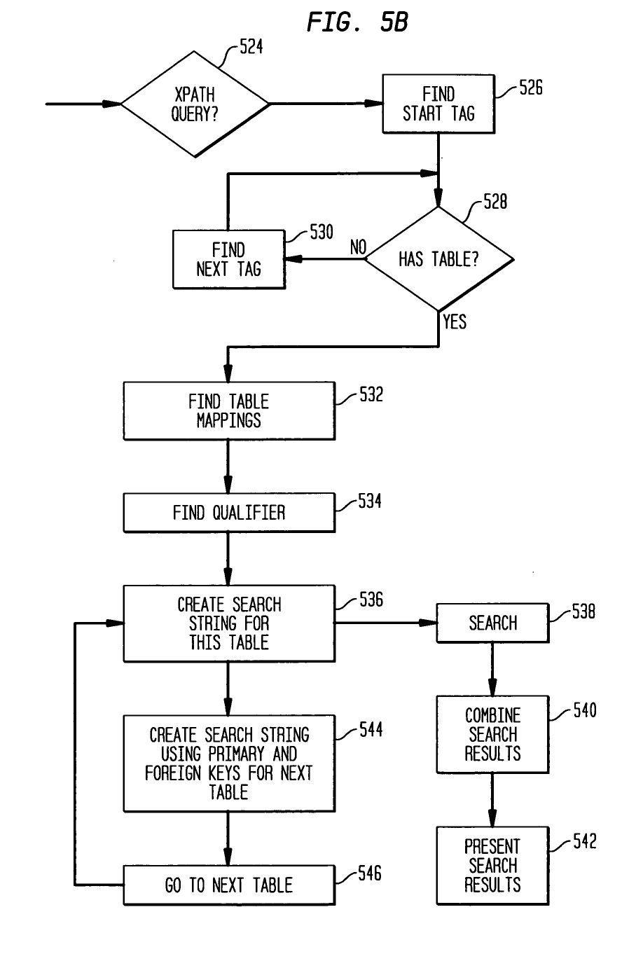

Once the database has been populated, it is important to be able to take a normal query and map it to one that is suitable to the database. XML is a hierarchical language and lends itself to a very structured grammar for making queries. To be able to make sure that the database generated above works effectively with such queries, the queries are mapped to Structured Query Language (SQL) statements where appropriate and then used to extract the appropriate entry from the document. There are several ways to query an XML document. The most common standard is XPath which shall be used in the following example as illustrated in FIGS. 5A and 5B.

A query string is received and the type of query is identified (502). If the query is a simple text query for a keyword, the query is mapped to a simple database query using SELECT and WHERE clauses and using OR to join searches from all the columns of all the tables (504). A database search is performed on the query (506). A text search is also performed for the rest of the system where the XML documents are stored (508). If a match is found in the database, the whole subnode of the XML tree up to the match point is extracted (510). If a match is found in the raw XML part of the system, the node is already identified. The search results are then presented to a user (512).

If the query is an advanced search query where multiple fields from different columns are specified, the query is mapped to a database search using a SELECT and WHERE clause and using AND to find the intersection of all searches (514). Once again this only takes care of the database mapped part of the system. It is possible however that the search words match different parts of the system, i.e. some of the words are in the raw XML part and some in the database part. As such all three possibilities are considered and searched, i.e. the match could be entirely in the XML part, or in the database or a mixed one (516, 518, 520). Regardless of the search being performed, all of the corresponding nodes are selected in exactly the same way as in the previous case (522). The search results are again presented to the user (512).

In accordance with the present invention, the most important search is that using an XPath statement (524). The XPath statements can either start at the root and follow all the way to specify the value of an element or an attribute or might just start at some point in the tree and specify the value of an element or attribute somewhere in the subtree. Thus the first step is to identify the location of the start tag in the query (526). A determination is made as to whether the start tag belongs to the raw XML part of the system or some table in the database.

The same procedure is performed for each element that is specified in the query string. If the whole segment is part of the XML segment of the system, the XML documents are searched to locate and identify the subtrees. If however, at some point it is apparent from the DTD that one of the elements belongs to the database part of the system, that part of the query is divided. The result is an XPath query that entirely is related to the database part of the system.

The next step is to determine if the start tag includes a table (528). If the start tag does not include a table, the next tag is found and a determination is made as to whether that tag includes a table (530). Reference is made to the DTD to determine how the particular hierarchy of the DTD maps to the table (532). Once the mapping is completed, the identity of the table to be searched is known. The actual search is done by converting the XPath query substring as an advanced search using SQL as described above (536). The identified table is searched for the corresponding element and attribute values that are specified using the SQL string (538). For a complex search query, the SQL string may include primary and foreign keys associated with the table (544). The next table is identified and a SQL string is created for that query (546). Once all of the tables have been searched, search results from each query are then combined (540). The search results are then presented to the user (542).

For example, a typical query for the spare parts catalog offering could be framed as:
//partslist/table/tbody/entry/para/link[@focus=‘01182”]

The query indicates a search for a table entry in the partslist table with a para that has a link whose attribute focus has the value ‘01182’. This is obviously a very complex search and needs to be mapped properly to the corresponding table. The only thing that is defined in the query is an attribute in the link table. By looking at the DTD, it is determined that the query directly refers to a table partslist in the database. In such a case, the query simply needs to be converted to one or more SQL statements. In that case, reference is made to the key that is defined and has a value and to the associated node that is queried. Thus the sequence of SQL steps are as follows:

SELECT distinct plink_pk FROM PLINK WHERE focus like ‘01182’
SELECT distinct FROM PARTSLIST WHERE
(plink_fk like ‘plink_pk’)

Note that in the previous query the highest level node that is defined is not a root node and thus the whole hierarchy is not provided. Now, the same query could have been framed as:
Anydoc/groupparts/partslist/table/tbody/entry/para/link[@focus=‘01182’]

To handle this we again go back to the DTD. And let's assume that anydoc is the root element. Hence we know that the whole hierarchy is specified. We go down the hierarchy and note again that partslist is mapped to the database. So again we break up the query to:
//partslist/table/tbody/entry/para/link[@focus=‘0182’]
   and handle it exactly the same way as before. Once we get all the matches, we go back to the actual XML documents from where we take the front part of the documents and retrieve them as results for the search.

Having described embodiments for a method for searching hybrid Extensible Markup Language (XML) documents, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method of generating a searchable database system for storing Extensible Markup Language (XML) documents, the method comprising the steps of:
analyzing a Document Type Description (DTD) associated with one or more XML documents to determine a scope of XML documents defined by the DTD;
identifying a first set of elements associated with the DTD;
mapping the first set-of elements to a relational database;
identifying a second set of elements associated with the DTD to be stored in an XML database;
creating a collection of classes, each class defining an object schema;
mapping the classes to a set of corresponding tables; and
identifying foreign and primary keys of the corresponding tables.

2. The method of claim 1 wherein the step of analyzing a DTD associated with one or more XML documents further comprises the steps of:
identifying a root element of the DTD;
for each node of the DTD, identifying child elements for each node;
for each child element, determining if the data is Parsable Character Data (PCDATA);
for each child element, determining if the data is Character Data (CDATA); and
for each child element, identifying attributes.

3. The method of claim 1 wherein the first set of elements are tabular.

4. The method of claim 1 wherein the second set of elements are non-tabular.

5. The method of claim 3 wherein the step of identifying a first set of elements associated with the DTD further comprises the steps of:
selecting a node of the DTD segment;
expanding the DID segment its entities definitions;
determining if children associated with the DID segment contain Character Data (CDATA) or Parseable Character Data (PCDATA); and
if the children associated with the DID segment contain CDAIA or PCDAIA, determining that the DID segment is tabular.

6. The method of claim 1 further comprising the steps of:
for each XML document, creating a document object model;
identifying the root element;
for each node associated with the root element, determining whether the node in the DID is to be mapped to a relational database table;
if the node is mapped to a relational database, disconnecting the node and creating a reference to an appropriate database table; and
if the node is not mapped to a relational database, examining the child 9 elements of the node.

7. A method of performing a hybrid search of Extensible Markup Language (XML) documents wherein a first set of segments of the XML documents are stored in a first database and a second set of segments of the XML documents are stored in a second database, the method comprising the steps of:
receiving a query string;
identifying a query type for the query string;
if the query is an XPath statement, identifying a location of a start tag for the query string;
determining if the query in the start tag is directed to the first database or the second database;
querying the appropriate database;
identifying each subsequent element in the query;
determining if each subsequent element is directed to the first database or the second database;
for those elements that are directed to the first database, converting each XPath statement substring to an advanced search query;
mapping the advanced search queries to an appropriate table;
performing the advanced search queries; and
combining the results of the advanced search queries to obtain search results.

8. The method of claim 7 wherein the first database is a relational database.

9. The method of claim 7 wherein the second database is an XML database.

10. The method of claim 7 wherein the advanced search query are Structured Query Language (SQL) statements.

11. The method of claim 10 wherein the SQL statement includes primary keys and foreign keys.
